(19) United States
(12) Patent Application Publication
(10) Pub. No.: US 2024/0007706 A1
(43) Pub. Date: Jan. 4, 2024

(54) DISPLAY DEVICE AND OPERATION METHOD THEREFOR

(71) Applicant: LG ELECTRONICS INC., Seoul (KR)

(72) Inventors: Kyungnam BAE, Seoul (KR); Eunjung LEE, Seoul (KR); Byounghyun SHIN, Seoul (KR); Jeonghwan KWON, Seoul (KR)

(73) Assignee: LG ELECTRONICS INC., Seoul (KR)

(21) Appl. No.: 18/038,308

(22) PCT Filed: Nov. 24, 2020
(86) PCT No.: PCT/KR2020/016707

§ 371 Date: May 23, 2023

(51) Int. Cl. H04N 21/4363; H04N 21/4408; H04N 21/41

(52) U.S. Cl. CPC H04N 21/4363; H04N 21/4408; H04N 21/4104

(57) ABSTRACT

The present disclosure relates to a display device and an operating method thereof, which improve a problem in which a screen is not output when operating as a receiver after operating as an HDCP repeater, the display device comprises a display unit and a control unit configured to: receive a signal from a first external device and transmit the signal to a second external device so that an image according to the signal received from the first external device is output from the second external device, wherein the control unit is further configured to transmit a virtual ID to the first external device if the second external device is not connected.

### TECHNICAL FIELD

The present disclosure relates to a display device and an operating method thereof, and more particularly, a display device and an operating method thereof transmitting/receiving a signal to/from a HDCP (High-bandwidth Digital Content Protection).

### BACKGROUND ART

Recently, a digital TV service using a wired or wireless communication network has become common. The digital TV service can provide various services that could not be provided in the existing analog broadcasting service.

For example, IPTV (Internet Protocol Television), a type of digital TV service, and smart TV service provide bi-directionality that allows users to actively select the type of program to watch and the viewing time. IPTV and smart TV services may provide various additional services, such as Internet search, home shopping, and online games, based on this interactive nature.

Also, the display device may be connected to an external device to receive content from the external device or transmit content to the external device. In this case, a transmitter that transmits content, such as an external device or a display device, may apply HDCP (High-bandwidth Digital Content Protection) to protect the content. HDCP is a technology that encrypts a path through which digital signal is transmitted and received, and is intended to prevent contents from being illegally copied.

Meanwhile, such a display device may serve as an HDCP repeater that receives and decrypts HDCP content from at least one external device, re-encrypts HDCP, and transmits the HDCP content to another external device. However, there is a limitation in that a display device that once operated as a repeater continues to be set as a repeater until it is rebooted. As a result, if the display device operates as a receiver that only receives HDCP content signals after operating as a repeater, there is a problem in that a screen is not output because an image is not transmitted from the transmitter.

### DISCLOSURE

### Technical Problem

An object of the present disclosure is to provide a display device and an operating method thereof that improve the problem of not outputting a screen if operating as a receiver after operating as an HDCP repeater.

An object of the present disclosure is to provide a display device and an operating method of thereof that improve compatibility problem caused by a high-bandwidth digital content protection (HDCP) operation mode.

### Technical Solution

According to an embodiment of the present disclosure, a display device may include a display unit and a control unit configured to: receive a signal from a first external device and transmit the signal to a second external device so that an image according to the signal received from the first external device is output from the second external device, wherein the control unit is further configured to transmit a virtual ID to the first external device if the second external device is not connected.
wherein the control unit may transmit a pre-stored value to the first external device as the virtual ID.
wherein after generating a random value, the control unit may transmit the generated random value to the first external device as the virtual ID.
wherein the control unit may transmit an ID of at least one second external device disconnected after the connection to the first external device as the virtual ID.
wherein if there is no previously connected second external device, the control unit may generate a random value and transmits the generated random value to the first external device as the virtual ID.
wherein the control unit may include a sink module configured to process a signal received from a first external device, a source module configured to transmit the signal to the second external device, and a virtual ID transmitting module configured to transmit the virtual ID to the first external device if the second external device is not connected.
wherein the control unit may operate in a first mode for receiving the signal from the first external device and displaying an image on the display unit, operate in a second mode for transmitting the signal to a second external device so that an image is output from the second external device, or operate in a third mode for transmitting the signal to the second external device so that an image according to the signal received from the first external device is output from the second external device.
wherein the control unit may transmit the virtual ID to the first external device when operating in the first mode after operating in the third mode.
wherein when operating in the first mode in a state where the third mode has never been operated, the control unit may transmit the virtual ID to the first external device.
wherein the first external device and the second external device may be connected to HDMI (High-Definition Multimedia Interface) or wireless communication.
wherein the control unit may transmit the virtual ID when authenticating with the first external device in a state where the second external device is not connected.
wherein the control unit may receive a signal encrypted with HDCP (High-bandwidth Digital Content Protection) when receiving the signal from the first external device, and transmit the signal encrypted with HDCP (High-bandwidth Digital Content Protection) when transmitting the signal to the second external device.
wherein the control unit may transmit a real ID of the second external device to the first external device if both the first external device and the second external device are connected.
wherein the virtual ID and the real ID of the second external device may be different.

According to an embodiment of the present disclosure, an operating method of a display device, comprising: receiving a signal from a first external device; transmitting the signal to a second external device so that an image according to the signal received from the first external device is output from the second external device; and transmitting a virtual ID to the first external device if the second external device is not connected.

### Advantageous Effects

According to the present disclosure, since a screen is normally output if operating as a receiver after operating as an HDCP repeater, there is an advantage in minimizing user inconvenience.

More specifically, as the display device operates as a receiver without being rebooted after operating as a repeater, the problem of not displaying the screen is solved, and the problem that it is difficult for users to understand the cause and solution of this problem can be improved.

### DESCRIPTION OF DRAWINGS

FIG. 1 is a block diagram illustrating a configuration of a display device according to an embodiment of the present invention.

FIG. 2 is a block diagram illustrating a remote control device according to an embodiment of the present invention.

FIG. 3 is a view illustrating an actual configuration of a remote control device according to an embodiment of the present invention.

FIG. 4 is a view of utilizing a remote control device according to an embodiment of the present invention.

FIG. 5 is a schematic diagram illustrating a display device operating as an HDCP repeater according to an embodiment of the present disclosure.

FIG. 6 is a diagram illustrating a display device further including a virtual ID transmission unit according to an embodiment of the present disclosure.

FIG. 7 is a flowchart illustrating a method of operating a display device according to an embodiment of the present disclosure.

### BEST MODE

Hereinafter, embodiments relating to the present invention will be described in detail with reference to the accompanying drawings. The suffixes “module” and “unit” for components used in the description below are assigned or mixed in consideration of easiness in writing the specification and do not have distinctive meanings or roles by themselves.

A display device according to an embodiment of the present invention, for example, as an artificial display device that adds a computer supporting function to a broadcast receiving function, can have an easy-to-use interface such as a writing input device, a touch screen, or a spatial remote control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS can be used.

Accordingly, since various applications are freely added or deleted on a general purpose OS kernel, a display device described herein, for example, can perform various user-friendly functions. The display device, in more detail, can be a network TV, Hybrid Broadcast Broadband TV (HBBTV), smart TV, light-emitting diode (LED) TV, organic light-emitting diode (OLED) TV, and so on and in some cases, can be applied to a smartphone.

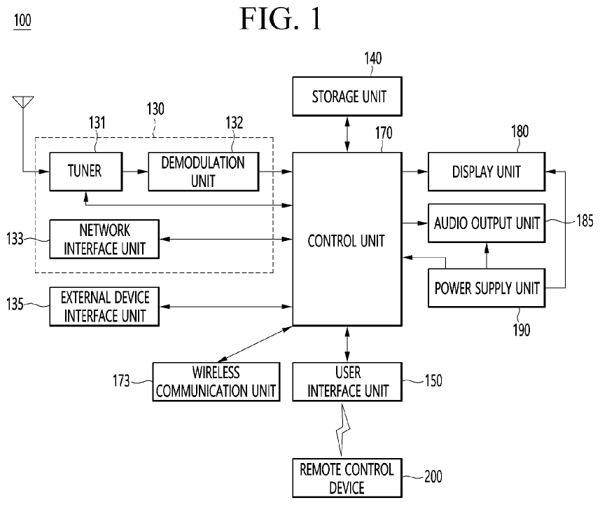

FIG. 1 is a block diagram illustrating a configuration of a display device according to an embodiment of the present invention.

Referring to FIG. 1, a display device 100 can include a broadcast reception unit 130, an external device interface unit 135, a storage unit 140, a user interface unit 150, a control unit 170, a wireless communication unit 173, a display unit 180, an audio output unit 185, and a power supply unit 190.

The broadcast reception unit 130 can include a tuner 131, a demodulation unit 132, and a network interface unit 133.

The tuner 131 can select a specific broadcast channel according to a channel selection command. The tuner 131 can receive broadcast signals for the selected specific broadcast channel.

The demodulation unit 132 can divide the received broadcast signals into video signals, audio signals, and broadcast program related data signals and restore the divided video signals, audio signals, and data signals to an output available form.

The external device interface unit 135 can receive an application or an application list in an adjacent external device and deliver it to the control unit 170 or the storage unit 140.

The external device interface unit 135 can provide a connection path between the display device 100 and an external device. The external device interface unit 135 can receive at least one an image or audio output from an external device that is wirelessly or wiredly connected to the display device 100 and deliver it to the control unit 170. The external device interface unit 135 can include a plurality of external input terminals. The plurality of external input terminals can include an RGB terminal, at least one High Definition Multimedia Interface (HDMI) terminal, and a component terminal.

An image signal of an external device input through the external device interface unit 135 can be output through the display unit 180. A sound signal of an external device input through the external device interface unit 135 can be output through the audio output unit 185.

An external device connectable to the external device interface unit 135 can be one of a set-top box, a Blu-ray player, a DVD player, a game console, a sound bar, a smartphone, a PC, a USB Memory, and a home theater system, but this is just exemplary.

The network interface unit 133 can provide an interface for connecting the display device 100 to a wired/wireless network including the Internet network. The network interface unit 133 can transmit or receive data to or from another user or another electronic device through an accessed network or another network linked to the accessed network.

Additionally, some content data stored in the display device 100 can be transmitted to a user or an electronic device, which is selected from other users or other electronic devices pre-registered in the display device 100.

The network interface unit 133 can access a predetermined webpage through an accessed network or another network linked to the accessed network. That is, the network interface unit 133 can transmit or receive data to or from a corresponding server by accessing a predetermined webpage through the network.

Then, the network interface unit 133 can receive contents or data provided from a content provider or a network operator. That is, the network interface unit 133 can receive contents such as movies, advertisements, games, VODs, and broadcast signals, which are provided from a content provider or a network provider, through network and information relating thereto.

Additionally, the network interface unit 133 can receive firmware update information and update files provided from a network operator and transmit data to an Internet or content provider or a network operator.

The network interface unit 133 can select and receive a desired application among applications open to the air, through network.

The storage unit 140 can store signal-processed image, voice, or data signals stored by a program in order for each signal processing and control in the control unit 170.

Additionally, the storage unit 140 can perform a function for temporarily storing image, voice, or data signals output from the external device interface unit 135 or the network interface unit 133 and can store information on a predetermined image through a channel memory function.

The storage unit 140 can store an application or an application list input from the external device interface unit 135 or the network interface unit 133.

The display device 100 can play content files (for example, video files, still image files, music files, document files, application files, and so on) stored in the storage unit 140 and provide them to a user.

The user interface unit 150 can deliver signals input by a user to the control unit 170 or deliver signals from the control unit 170 to a user. For example, the user interface unit 150 can receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR.

Additionally, the user interface unit 150 can deliver, to the control unit 170, control signals input from local keys (not shown) such as a power key, a channel key, a volume key, and a setting key.

Image signals that are image-processed in the control unit 170 can be input to the display unit 180 and displayed as an image corresponding to corresponding image signals. Additionally, image signals that are image-processed in the control unit 170 can be input to an external output device through the external device interface unit 135.

Voice signals processed in the control unit 170 can be output to the audio output unit 185. Additionally, voice signals processed in the control unit 170 can be input to an external output device through the external device interface unit 135.

Besides that, the control unit 170 can control overall operations in the display device 100. Additionally, the control unit 170 can control the display device 100 by a user command or internal program input through the user interface unit 150 and download a desired application or application list into the display device 100 in access to network.

The control unit 170 can output channel information selected by a user together with processed image or voice signals through the display unit 180 or the audio output unit 185.

Additionally, according to an external device image playback command received through the user interface unit 150, the control unit 170 can output image signals or voice signals of an external device such as a camera or a camcorder, which are input through the external device interface unit 135, through the display unit 180 or the audio output unit 185.

Moreover, the control unit 170 can control the display unit 180 to display images and control broadcast images input through the tuner 131, external input images input through the external device interface unit 135, images input through the network interface unit, or images stored in the storage unit 140 to be displayed on the display unit 180. In this case, an image displayed on the display unit 180 can be a still image or video and also can be a 2D image or a 3D image.

Additionally, the control unit 170 can play content stored in the display device 100, received broadcast content, and external input content input from the outside, and the content can be in various formats such as broadcast images, external input images, audio files, still images, accessed web screens, and document files.

Moreover, the wireless communication unit 173 can perform a wired or wireless communication with an external electronic device. The wireless communication unit 173 can perform short-range communication with an external device. For this, the wireless communication unit 173 can support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 can support wireless communication between the display device 100 and a wireless communication system, between the display device 100 and another display device 100, or between networks including the display device 100 and another display device 100 (or an external server) through wireless area networks. The wireless area networks can be wireless personal area networks.

Herein, the other display device 100 can be a mobile terminal such as a wearable device (for example, a smart watch, a smart glass, and a head mounted display (HMD)) or a smartphone, which is capable of exchanging data (or inter-working) with the display device 100. The wireless communication unit 173 can detect (or recognize) a communicable wearable device around the display device 100. Furthermore, if the detected wearable device is a device authenticated to communicate with the display device 100, the control unit 170 can transmit at least part of data processed in the display device 100 to the wearable device through the wireless communication unit 173. Accordingly, a user of the wearable device can use the data processed in the display device 100 through the wearable device.

The display unit 180 can convert image signals, data signals, or on-screen display (OSD) signals, which are processed in the control unit 170, or images signals or data signals, which are received in the external device interface unit 135, into R, G, and B signals to generate driving signals.

Furthermore, the display device 100 shown in FIG. 1 is just one embodiment of the present invention and thus, some of the components shown can be integrated, added, or omitted according to the specification of the actually implemented display device 100.

That is, if necessary, two or more components can be integrated into one component or one component can be divided into two or more components and configured. Additionally, a function performed by each block is to describe an embodiment of the present invention and its specific operation or device does not limit the scope of the present invention.

According to another embodiment of the present invention, unlike FIG. 1, the display device 100 can receive images through the network interface unit 133 or the external device interface unit 135 and play them without including the tuner 131 and the demodulation unit 132.

For example, the display device 100 can be divided into an image processing device such as a set-top box for receiving broadcast signals or contents according to various network services and a content playback device for playing contents input from the image processing device.

In this case, an operating method of a display device according to an embodiment of the present invention described below can be performed by one of the display device described with reference to FIG. 1, an image processing device such as the separated set-top box, and a content playback device including the display unit 180 and the audio output unit 185.

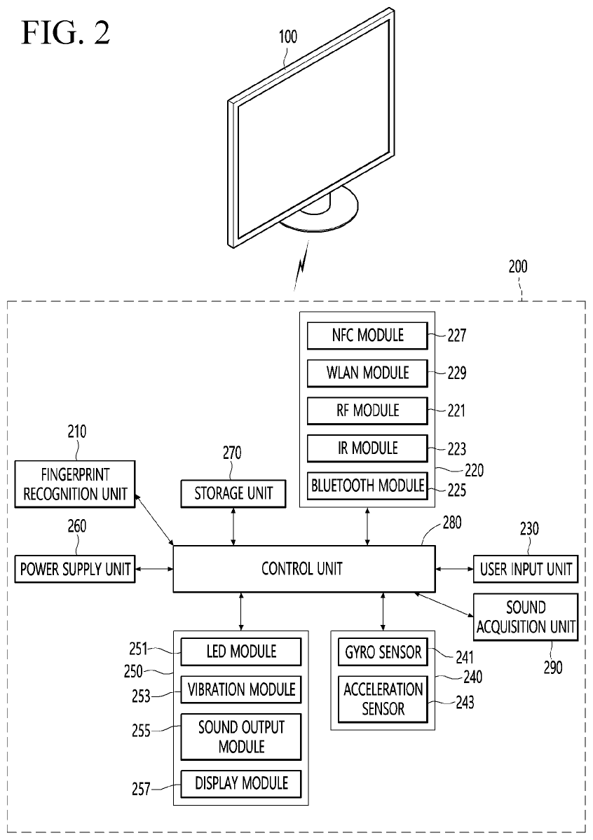

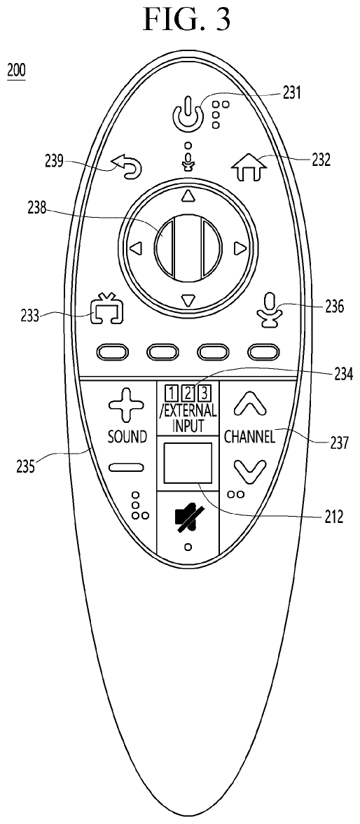

Then, referring to FIGS. 2 and 3, a remote control device is described according to an embodiment of the present invention.

FIG. 2 is a block diagram illustrating a remote control device according to an embodiment of the present invention and FIG. 3 is a view illustrating an actual configuration of a remote control device according to an embodiment of the present invention.

First, referring to FIG. 2, a remote control device 200 can include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present invention.

The remote control device 200 can include a radio frequency (RF) module 221 for transmitting/receiving signals to/from the display device 100 according to the RF communication standards and an IR module 223 for transmitting/receiving signals to/from the display device 100 according to the IR communication standards. Additionally, the remote control device 200 can include a Bluetooth module 225 for transmitting/receiving signals to/from the display device 100 according to the Bluetooth communication standards. Additionally, the remote control device 200 can include a Near Field Communication (NFC) module 227 for transmitting/receiving signals to/from the display device 100 according to the NFC communication standards and a WLAN module 229 for transmitting/receiving signals to/from the display device 100 according to the Wireless LAN (WLAN) communication standards.

Additionally, the remote control device 200 can transmit signals containing information on a movement of the remote control device 200 to the display device 100 through the wireless communication unit 220.

Moreover, the remote control device 200 can receive signals transmitted from the display device 100 through the RF module 221 and if necessary, can transmit a command on power on/off, channel change, and volume change to the display device 100 through the IR module 223.

The user input unit 230 can be configured with a keypad button, a touch pad, or a touch screen. A user can manipulate the user input unit 230 to input a command relating to the display device 100 to the remote control device 200. If the user input unit 230 includes a hard key button, a user can input a command relating to the display device 100 to the remote control device 200 through the push operation of the hard key button. This will be described with reference to FIG. 3.

Referring to FIG. 3, the remote control device 200 can include a plurality of buttons. The plurality of buttons can include a fingerprint recognition button 212, a power button 231, a home button 232, a live button 233, an external input button 234, a voice adjustment button 235, a voice recognition button 236, a channel change button 237, a check button 238, and a back button 239.

The fingerprint recognition button 212 can be a button for recognizing a user's fingerprint. According to an embodiment of the present invention, the fingerprint recognition button 212 can perform a push operation and receive a push operation and a fingerprint recognition operation. The power button 231 can be button for turning on/off the power of the display device 100. The home button 232 can be a button for moving to the home screen of the display device 100. The live button 233 can be a button for displaying live broadcast programs. The external input button 234 can be a button for receiving an external input connected to the display device 100. The voice adjustment button 235 can be a button for adjusting the size of a volume output from the display device 100. The voice recognition button 236 can be a button for receiving user's voice and recognizing the received voice. The channel change button 237 can be a button for receiving broadcast signals of a specific broadcast channel. The check button 238 can be a button for selecting a specific function and the back button 239 can be a button for returning to a previous screen.

Again, referring to FIG. 2, if the user input unit 230 includes a touch screen, a user can touch a soft key of the touch screen to input a command relating to the display device 100 to the remote control device 200. Additionally, the user input unit 230 can include various kinds of input means manipulated by a user, for example, a scroll key and a jog key, and this embodiment does not limit the scope of the present invention.

The sensor unit 240 can include a gyro sensor 241 or an acceleration sensor 243 and the gyro sensor 241 can sense information on a movement of the remote control device 200.

For example, the gyro sensor 241 can sense information on an operation of the remote control device 200 on the basis of x, y, and z axes and the acceleration sensor 243 can sense information on a movement speed of the remote control device 200. Moreover, the remote control device 200 can further include a distance measurement sensor and sense a distance with respect to the display unit 180 of the display device 100.

The output unit 250 can output image or voice signals in response to manipulation of the user input unit 230 or image or voice signals corresponding to signals transmitted from the display device 100. A user can recognize whether the user input unit 230 is manipulated or the display device 100 is controlled through the output unit 250.

For example, the output unit 250 can include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste can be reduced. The power supply unit 260 can resume the power supply if a predetermined key provided at the remote control device 200 is manipulated.

The storage unit 270 can store various kinds of programs and application data necessary for control or operation of the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 can store, in the storage unit 270, information on a frequency band for transmitting/receiving signals to/from the display device 100 paired with the remote control device 200 and refer to it.

The control unit 280 controls general matters relating to control of the remote control device 200. The control unit 280 can transmit a signal corresponding to a predetermined key manipulation of the user input unit 230 or a signal corresponding to movement of the remote control device 200 sensed by the sensor unit 240 to the display device 100 through the wireless communication unit 220.

Additionally, the sound acquisition unit 290 of the remote control device 200 can obtain voice. The sound acquisition unit 290 can include at least one microphone and obtain voice through the microphone 291.

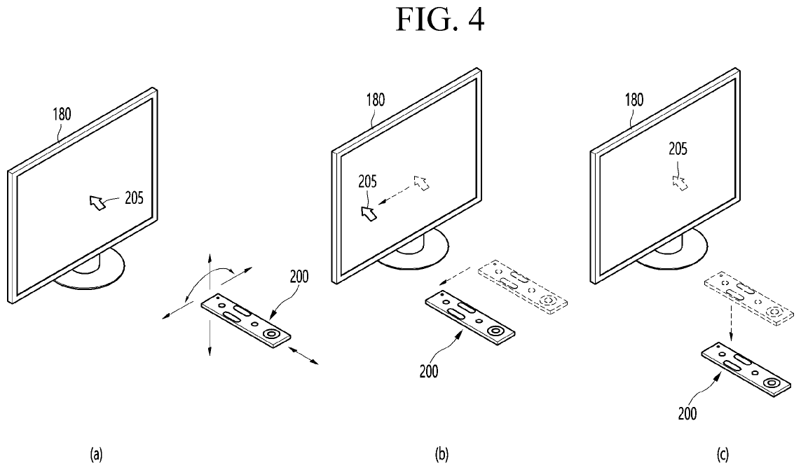

FIG. 4 is a view of utilizing a remote control device according to an embodiment of the present invention. FIG. 4(a) illustrates that a pointer 205 corresponding to the remote control device 200 is displayed on the display unit 180.

A user can move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 can be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 can calculate the coordinates of the pointer 205 from the information on the movement of the remote control device 200. The display device 100 can display the pointer 205 to match the calculated coordinates.

FIG. 4(c) illustrates that while a specific button in the remote control device 200 is pressed, a user moves the remote control device 200 away from the display unit 180. Thus, a selection area in the display unit 180 corresponding to the pointer 205 can be zoomed in and displayed larger.

On the other hand, if a user moves the remote control device 200 close to the display unit 180, a selection area in the display unit 180 corresponding to the pointer 205 can be zoomed out and displayed in a reduced size.

On the other hand, if the remote control device 200 is moved away from the display unit 180, a selection area can be zoomed out and if the remote control device 200 is moved closer to the display unit 180, a selection area can be zoomed in.

Additionally, if a specific button in the remote control device 200 is pressed, recognition of a vertical or horizontal movement can be excluded. That is, if the remote control device 200 is moved away from or closer to the display unit 180, the up, down, left, or right movement cannot be recognized and only the back and forth movement can be recognized. While a specific button in the remote control device 200 is not pressed, only the pointer 205 is moved according to the up, down, left or right movement of the remote control device 200.

Moreover, the moving speed or moving direction of the pointer 205 can correspond to the moving speed or moving direction of the remote control device 200.

Furthermore, a pointer in this specification means an object displayed on the display unit 180 in response to an operation of the remote control device 200. Accordingly, besides an arrow form displayed as the pointer 205 in the drawing, various forms of objects are possible. For example, the above concept includes a point, a cursor, a prompt, and a thick outline. Then, the pointer 205 can be displayed in correspondence to one point of a horizontal axis and a vertical axis on the display unit 180 and also can be displayed in correspondence to a plurality of points such as a line and a surface.

Meanwhile, the display device 100 may be connected to an external device to transmit and receive HDCP (High-bandwidth Digital Content Protection) signal. The display device 100 may operate as an HDCP transmitter that transmits an HDCP signal to an external device, or as an HDCP receiver that receives an HDCP signal from an external device, or as an HDCP signal from any one external device. It can operate as an HDCP repeater (HDCP repeater) that receives and transmits to other external device.

HDCP Transmitter refers to a device that encrypts and transmits HDCP content through an HDCP protected interface port, HDCP Receiver refers to a device that receives and decrypts HDCP content through an HDCP protected interface port, and HDCP repeater refers to a device that transmits HDCP content through a DCP protected interface port. It may refer to a device that receives and decrypts HDCP content through an interface port, and encrypts and transmits HDCP content through an HDCP protected interface port.

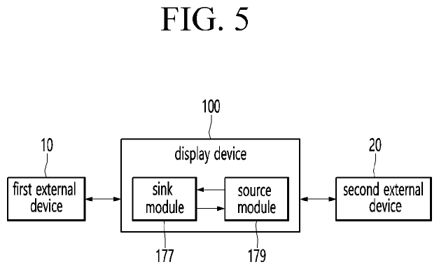

FIG. 5 is a schematic diagram illustrating a display device operating as an HDCP repeater according to an embodiment of the present disclosure.

As shown in FIG. 5, the display device 100 may include at least some or all of the sink module 177 and the source module 179.

The sink module 177 may have an HDCP protection interface port and be a module that receives and decrypts signal from external devices, and the source module 179 may have an HDCP protection interface port and be a module that encrypts and transmits signal.

Although the sink module 177 and the source module 179 are shown as separate components in FIG. 5, this is for convenience of description and may be formed as an integral module. Also, the sink module 177 and the source module 179 may be formed as component separate from the components shown in FIG. 1 or may be formed inside any one of the components shown in FIG. 1. For example, the sink module 177 and the source module 179 may be provided in at least one of the control unit 170, the network interface unit 133, the external device interface unit 135, and the voice communication unit 173 of FIG. 1.

At least one external device that transmits and receives signals to and from the display device 100 may be connected wirelessly through HDMI (High Definition Multimedia Interface), DVI (Digital Visual Interface), or Bluetooth, Wi-Fi, or the like. That is, the present disclosure is not limited to a connection method between the display device 100 and an external device.

As shown in FIG. 5, the display device 100 it may operate as an HDCP repeater (hereinafter referred to as ‘repeater’) if the display device 100 is connected to a first external device 10 that shares content through a sink module 177 and a second external device (20) that shares content through a source module 179. And, in this case, the display device 100 operates as an HDCP receiver (hereinafter referred to as ‘receiver’) in relation to the first external device 10, and at this time, the first external device 10 may be a HDCP transmitter (hereinafter referred to as ‘transmitter’) or an HDCP repeater (in this case, the first external device 10 may be serving to receive signal from other external device and transmit them to the display device 100). In addition, the display device 100 operates as an HDCP transmitter in relation to the second external device 20, and at this time, the second external device 20 may be a HDCP receiver or HDCP repeater (in this case, the second external device 20 may be serving to transmit a signal received from the display device 100 to another external device).

The first external device 10 and the second external device 20 may be connected by either wired communication or wireless communication, such as High-Definition Multimedia Interface (HDMI), respectively.

The display device 100 may perform authentication when connected to the first external device 10 and when connected to the second external device 20. The display device 100 may transmit and receive a message including parameters such as ID, LENGTH, VERSION, and TRANSMITTER_CAPABILITY_MASK with the first external device 10 as a HDCP receiver in relation to the first external device 10, and complete authentication by transmitting and receiving message including parameters such as ID, LENGTH, VERSION, and TRANSMITTER_CAPABILITY_MASK with the second external device 20 as a HDCP transmitter in relation to the second external device 20. Also, when the display device 100 performs authentication with the second external device 20, the version of the display device 100 may be downgraded according to the version of the second external device 20 to complete authentication.

If the display device 100 completes authentication, the source module 179 may transfer the ID of the second external device 20 to the sink module 177, and the sink module 177 may receive the received ID of the second external device 20 from the source module 179 and transmit to the first external device 10. At this time, the first external device 10 may check validity, connect to HDCP, and similarly downgrade the version.

Here, the ID is an ID provided as a source by the sink or repeater side in a device-to-device authentication process to protect content, and may be a Key Selection Vector (KSV).

In this way, if the authentication with the first external device 10 and the second external device 20 is completed, the display device 100 may receive and decrypt the content from the first external device 10, and may encrypt the content again and transmit the encrypted content to the second external device (20).

In FIG. 5, the case where the display device 100 operates as a repeater has been described, but the display device 100 may operate as a transmitter or a receiver. That is, the control unit 170 may be operated in a receiver mode (first mode) for receiving a signal from the first external device 10 and displaying an image on the display unit 180, or may be operated in a transmitter mode (second mode) that transmits signal to the second external device 20 to be output an image to the second external device 20, or may be operated in a repeater mode (third mode) for transmitting signal to the external device 20 to be output an image according to a signal received from the first external device 10 to the second external device 20.

If the operation mode is set to one of the receiver mode, the transmitter mode, and the repeater mode after booting, the control unit 170 can maintain the set operation mode even if the connection state with the external device is changed. That is, if the operation mode is set to the repeater mode after booting, the control unit 170 may maintain the repeater mode until rebooting.

Meanwhile, in a state in which the display device 100 operates in the repeater mode and is not rebooted, only the first external device 10 may be connected to operate as a receiver, and the second external device 20 may not be connected. That is, in a state in which the operation mode of the display device 100 is maintained as the repeater mode, only the first external device 10 which is a transmitter may be connected, and the second external device 20 may not be connected. In this case, the display device 100 needs to receive a signal from the first external device 10 and output an image, but a problem may occur in that the first external device 10 does not transmit a signal to the display device 100. The first external device 10 recognizes the display device 100 as a repeater mode, but does not receive the ID of the second external device 20 connected to the display device 100, and thus may not transmit signal to the display device 100. Therefore, in this case, it is difficult for the user to know why the image of the first external device 10 is not displayed on the display device 100, and may misinterpret it as a problem with the display device 100.

Accordingly, if only the first external device 10 is connected in the repeater mode, the display device 100 according to an embodiment of the present disclosure may transmit a virtual ID to the first external device 10, so that the first external device 10 may transmit a signal to the display device 100.

To this end, according to an embodiment, the display device 100 may further include a virtual ID transmitting unit 178.

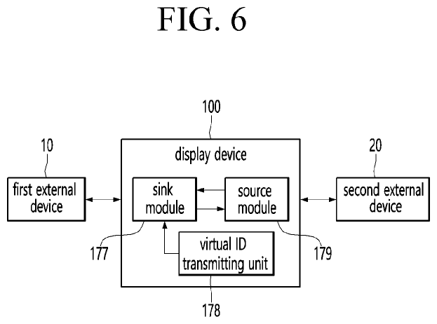

FIG. 6 is a diagram illustrating a display device further including a virtual ID transmission unit according to an embodiment of the present disclosure.

Hereinafter, descriptions overlapping with those shown in FIG. 5 will be omitted in relation to some components shown in FIG. 6.

As shown in FIG. 6, the display device 100 may include a sink module 177, a source module 179 and a virtual ID transmitting unit 178.

The sink module 177 may process the signal received from the first external device 10, the source module 179 may transmit the signal to the second external device 20, and the virtual ID transmitting unit 178 may transmit the signal to the first external device 10 if the second external device 20 is not connected.

Meanwhile, the virtual ID transmitting unit 178 may be one component of the control unit 170. Alternatively, the virtual ID transmitting unit 178 may be a separate and independent component from the control unit 170 and the display unit 180. That is, the virtual ID transmitting unit 178 may be formed in various ways. In the present disclosure, it is assumed that each of the sink module 177, the virtual ID transmitting unit 178, and the source module 179 is one component of the control unit 170.

The virtual ID transmitting unit 178 may transmit a virtual ID to the sync module 177 so that the first external device 10 recognizes the display device 100 as a receiver mode. That is, the control unit 170 may transmit a virtual ID to the first external device 10 so that the first external device 10 recognizes the display apparatus 100 as a receiver mode.

The virtual ID transmitting unit 178 may transmit a virtual ID to the sync module 177 if the operation mode is the repeater mode but the second external device 20 is not connected. That is, the control unit 170 may transmit a virtual ID to the first external device 10 if the operation mode is the repeater mode but the second external device 20 is not connected.

The virtual ID transmitting unit 178 may transmit a virtual ID to the sync module 177 if the operation mode is a repeater mode but only the first external device 10 is connected. That is, the control unit 170 may transmit a virtual ID to the first external device 10 if the operation mode is a repeater mode but only the first external device 10 is connected.

The virtual ID transmitting unit 178 may transmit a virtual ID the sync module 177 if the second external device 20 is not connected while in the repeater mode which receives a signal from the first external device 10 and outputs an image according to the signal received from the first external device 10 to the second external device 20. That is, the control unit 170 may transmit a virtual ID to the first external device 10 if the second external device 20 is not connected while operating in the repeater mode.

The virtual ID transmitting unit 178 may transmit a virtual ID to the sink module 177 when authenticating with the first external device 10 to operate in the receiver mode in a state where the second external device 20 is not connected. That is, the control unit 170 may transmit a virtual ID to the first external device 10 when authenticating with the first external device 10 to operate in the receiver mode in a state where the second external device 20 is not connected.

That is, the control unit 170 according to an embodiment of the present disclosure may transmit a virtual ID to the first external device 10 if the ID information of the second external device 20 is zero.

Meanwhile, the virtual ID transmitted by the virtual ID transmitting unit 178 to the sink module 177 may be various, which will be described in detail below.

According to the first embodiment, the control unit 170 may transmit a pre-stored value to the first external device 10 as a virtual ID. Specifically, if the virtual ID transmitting unit 178 transmits a value set as default and stored in the storage unit 140 to the sink module 177 as the virtual ID, the sink module 177 may transmit the virtual ID received from the virtual ID transmitting unit 178 to the first external device 10.

According to the second embodiment, the control unit 170 may generate a random value and transmit the generated random value to the first external device 10 as a virtual ID. Specifically, whenever virtual ID transmission is requested, the virtual ID transmission unit 178 generates a random value in the form of a 5-byte hexadecimal value and transmits it to the sink module 177, the sink module 177 may transmit the virtual ID received from the virtual ID transmitting unit 178 to the first external device 10.

According to the third embodiment, the control unit 170 may transmit, to the first external device 10, the ID of at least one second external device 20 disconnected as a virtual ID after pre-connection. Specifically, the virtual ID transmitting unit 178 may store the ID of at least one second external device 20 previously connected and then disconnected, and whenever virtual ID transmission is requested, if the ID of the stored previously connected second external device (20) is transmitted to the sync module 177, the sync module 177 may transmit the ID received from the virtual ID transmitting 178 to the first external device 10. For example, the virtual ID transmitting unit 178 may transmit the ID of the second external device 20 that was most recently connected and disconnected to the sync module 177. Meanwhile, even in this case, if there is no previously connected second external device, the control unit 170 may generate a random value and transmit the generated random value to the first external device 10 as a virtual ID.

This virtual ID may be different from the real ID of the second external device 20. Specifically, the control unit 170 transmits the real ID of the second external device 20 to the first external device 10 when both the first external device 10 and the second external device 20 are connected. At this time, the real ID of the second external device 20 may be different from the above-described virtual ID.

Meanwhile, the display device 100 is not limited to implementing only one of the above-described first to third embodiments, and may selectively implement the first to third embodiments among situations or preset information.

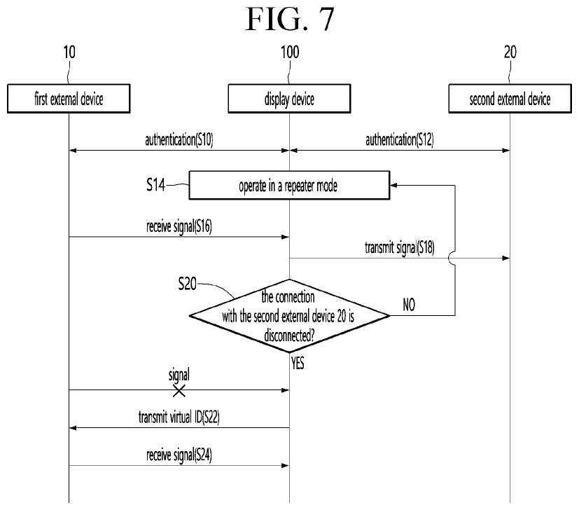

FIG. 7 is a flowchart illustrating a method of operating a display device according to an embodiment of the present disclosure.

The control unit 170 of the display device 100 may perform authentication with the first external device 10 (S10) and authentication with the second external device 20 (S12).

Here, the authentication may be an action is performed by transmitting and receiving information such as id, LENGTH, and VERSION to each other as message between the display device 100 and the external device to exchange information of the external device with each other when the display device 100 is connected to an external device.

if authentication is completed with each of the first external device 10 and the second external device 20, the control unit 170 of the display device 100 may operate in a repeater mode (S14).

If the display device 100 may complete authentication only with the first external device 10, it may be operated in a transmitter mode, and if it may complete authentication with only the second external device 20, it may be operated in a receiver mode.

The control unit 170 of the display device 100 may receive a signal from the first external device 10 while operating in the repeater mode (S16) and transmit the signal to the second external device 20 according to the received signal.

The control unit 170 may receive a signal encrypted with HDCP (High-bandwidth Digital Content Protection) when receiving a signal from the first external device 10, and may transmit encrypted signal with HDCP (High-bandwidth Digital Content Protection) when transmitting the signal to the second external device.

The signal received from the first external device 10 and the signal transmitted to the second external device 20 may be the same or may be processed signals as needed.

The control unit 170 of the display device 100 may recognize whether or not the connection with the second external device 20 is disconnected (S20).

If disconnection from the second external device 20 is not recognized, the control unit 170 of the display device 100 may continue to operate in a repeater mode, receive a signal from the first external device 10, and transmit the signal to the external device 20.

Meanwhile, the control unit 170 of the display device 100 may not receive a signal from the first external device 10 if disconnection with the second external device 20 is recognized.

In this case, the control unit 170 of the display device 100 may transmit a virtual ID to the first external device 10 (S22) and receive a signal from the first external device 10 accordingly (S24).

In summary, the control unit 170 may transmit a virtual ID to the first external device 10 when operating in the receiver mode after operating in the repeater mode.

On the other hand, the control unit 170 may not transmit a virtual ID to the first external device 10 when operating in the receiver mode in a state where it has never operated in the repeater mode. This is because the control unit 170 can receive a signal from the first external device 10 without transmitting a virtual ID.

Accordingly, the control unit 170 may not transmit a virtual ID to the first external device 10 when operating in the receiver mode in a rebooted state after operating in the repeater mode. This is because the operation mode of the control unit 170 is initialized as it is rebooted.

According to an embodiment of the present disclosure, the above-described method can be implemented as a processor-readable code in a medium on which a program is recorded. Examples of media readable by the processor include ROM, RAM, CD-ROM, magnetic tape, floppy disk, optical data storage, and the like.

The above-described display device is not limited to the configuration and method of the above-described embodiments, but the above embodiments may be configured by selectively combining all or part of each embodiment so that various modifications can be made.

The above description is merely an example of the technical spirit of the present disclosure, and various modifications and variations may be made to those skilled in the art without departing from the essential characteristics of the present disclosure.

Therefore, the embodiments disclosed in this specification are not intended to limit the technical spirit of the present specification, but to explain, and the scope of the technical spirit of the present specification is not limited by these embodiments.

The protection scope of this specification should be interpreted by the claims below, and all technical ideas within the equivalent range should be construed as being included in the scope of rights of this specification.

1. A display device comprising:
a display unit; and
a control unit configured to:
receive a signal from a first external device and
transmit the signal to a second external device so that an image according to the signal received from the first external device is output from the second external device,
wherein the control unit is further configured to transmit a virtual ID to the first external device if the second external device is not connected.

2. The display device of claim 1, wherein the control unit transmits a pre-stored value to the first external device as the virtual ID.

3. The display device of claim 1, wherein after generating a random value, the control unit transmits the generated random value to the first external device as the virtual ID.

4. The display device of claim 1, wherein the control unit transmits an ID of at least one second external device disconnected after the connection to the first external device as the virtual ID.

5. The display device of claim 4, wherein if there is no previously connected second external device, the control unit generates a random value and transmits the generated random value to the first external device as the virtual ID.

6. The display device of claim 1, wherein the control unit includes:
a sink module configured to process a signal received from a first external device,
a source module configured to transmit the signal to the second external device, and
a virtual ID transmitting module configured to transmit the virtual ID to the first external device if the second external device is not connected.

7. The display device of claim 1, wherein the control unit operates in a first mode for receiving the signal from the first external device and displaying an image on the display unit,
operates in a second mode for transmitting the signal to a second external device so that an image is output from the second external device, or
operates in a third mode for transmitting the signal to the second external device so that an image according to the signal received from the first external device is output from the second external device.

8. The display device of claim 7, wherein the control unit transmits the virtual ID to the first external device when operating in the first mode after operating in the third mode.

9. The display device of claim 7, wherein when operating in the first mode in a state where the third mode has never been operated, the control unit transmits the virtual ID to the first external device.

10. The display device of claim 1, wherein the first external device and the second external device are each connected to HDMI (High-Definition Multimedia Interface) or wireless communication.

11. The display device of claim 1, wherein the control unit transmits the virtual ID when authenticating with the first external device in a state where the second external device is not connected.

12. The display device of claim 1, wherein the control unit receives a signal encrypted with HDCP (High-bandwidth Digital Content Protection) when receiving the signal from the first external device, and
transmits the signal encrypted with HDCP (High-bandwidth Digital Content Protection) when transmitting the signal to the second external device.

13. The display device of claim 1, wherein the control unit transmits a real ID of the second external device to the first external device if both the first external device and the second external device are connected.

14. The display device of claim 13, wherein the virtual ID and the real ID of the second external device are different.

15. An operating method of a display device, comprising:
receiving a signal from a first external device;
transmitting the signal to a second external device so that an image according to the signal received from the first external device is output from the second external device; and
transmitting a virtual ID to the first external device if the second external device is not connected.
